(19) United States
(12) Patent Application Publication
(10) Pub. No.: US 2024/0140454 A1
(43) Pub. Date: May 2, 2024

(54) ON-VEHICLE SYSTEM

(71) Applicant: TOYOTA JIDOSHA KABUSHIKI KAISHA, Toyota-shi Aichi (JP)

(72) Inventors: Tomohiro Kaneko, Mishima-shi Shizuoka (JP); Shigeki Nakayama, Gotenba-shi Shizuoka (JP); Kotoru Sato, Hadano-shi Kanagawa (JP)

(73) Assignee: TOYOTA JIDOSHA KABUSHIKI KAISHA, Toyota-shi Aichi (JP)

(21) Appl. No.: 18/369,953

(22) Filed: Sep. 19, 2023

(30) Foreign Application Priority Data
Nov. 2, 2022 (JP) 2022-176520

(51) Int. Cl. B60W 50/08; B60W 40/08; G06V 10/70; G06V 20/52; G06V 20/59; G06V 40/16

(52) U.S. Cl. CPC B60W 50/087; B60W 40/08; G06V 10/70; G06V 20/52; G06V 20/59; G06V 40/174; B60W 2040/0872; B60W 2420/42; B60W 2540/229

(57) ABSTRACT

An on-vehicle system includes: a control device; a monitoring device that monitors whether each of a plurality of occupants in a vehicle has grasped a behavior of the vehicle; and a storage device that stores a learned model for feeling estimation. Further, the control device determines whether there is an occupant who has not grasped a behavior of the vehicle among the plurality of occupants based on a monitoring result of the monitoring device, specifies a target occupant whose feeling is to be estimated from the plurality of occupants based on the determination result, estimates feeling of the target occupant who has been specified by using the learned model, and executes vehicle control in accordance with a result of estimating the feeling of the target occupant.

### CROSS-REFERENCE TO RELATED APPLICATION(S)

The present application claims priority to and incorporates by reference the entire contents of Japanese Patent Application No. 2022-176520 filed in Japan on Nov. 2, 2022.

### BACKGROUND

The present disclosure relates to an on-vehicle system.

Japanese Laid-open Patent Publication No. 2019-098779 discloses a technique for generating driving advice based on a feeling difference between a driver and an occupant.

### SUMMARY

There is a need for providing an on-vehicle system capable of inhibiting an occupant who has not grasped the behavior of a vehicle from being unpleasant.

According to an embodiment, an on-vehicle system includes: a control device; a monitoring device that monitors whether each of a plurality of occupants in a vehicle has grasped a behavior of the vehicle; and a storage device that stores a learned model for feeling estimation. Further, the control device determines whether there is an occupant who has not grasped a behavior of the vehicle among the plurality of occupants based on a monitoring result of the monitoring device, specifies a target occupant whose feeling is to be estimated from the plurality of occupants based on the determination result, estimates feeling of the target occupant who has been specified by using the learned model, and executes vehicle control in accordance with a result of estimating the feeling of the target occupant.

### BRIEF DESCRIPTION OF THE DRAWINGS

FIG. 1 schematically illustrates a vehicle in which an on-vehicle system according to a first embodiment is mounted;

FIG. 2 is a flowchart illustrating one example of control performed by a control device;

FIG. 3 schematically illustrates a vehicle in which an on-vehicle system according to a second embodiment is mounted;

FIG. 4 schematically illustrates a vehicle in which an on-vehicle system according to a third embodiment is mounted; and

FIG. 5 schematically illustrates a vehicle in which an on-vehicle system according to a fourth embodiment is mounted.

### DETAILED DESCRIPTION

In the related art, when an occupant has not grasped the behavior of a vehicle, such as accelerating, decelerating, right turning, left turning, and step following, the occupant easily has an unpleasant feeling such as carsickness.

### First Embodiment

A first embodiment of an on-vehicle system according to the present disclosure will be described below. Note that the present embodiment does not limit the present disclosure.

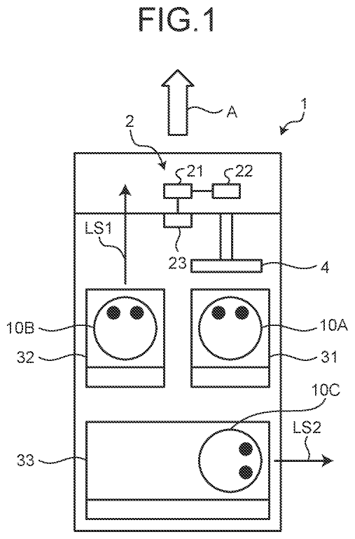

FIG. 1 schematically illustrates a vehicle 1 in which an on-vehicle system 2 according to the first embodiment is mounted.

As illustrated in FIG. 1, the vehicle 1 according to the embodiment includes the on-vehicle system 2, a steering wheel 4, front seats 31 and 32, and a rear seat 33. Note that an arrow A in FIG. 1 indicates a traveling direction of the vehicle 1.

Occupants 10A, 10B, and 10C are seated on the front seats 31 and 32 and the rear seat 33, respectively. The occupant 10A seated on the front seat 31 facing the steering wheel 4 is a driver of the vehicle 1. An arrow LS1 in FIG. 1 indicates the direction of the line of sight of the occupant 10B. An arrow LS2 in FIG. 1 indicates the direction of the line of sight of the occupant 10C. Note that, in the following description, the occupants 10A, 10B, and 10C are simply referred to as occupants 10 unless otherwise distinguished.

The on-vehicle system 2 includes a control device 21, a storage device 22, and an in-vehicle camera 23.

The control device 21 includes, for example, an integrated circuit including a central processing unit (CPU). The control device 21 executes a program and the like stored in the storage device 22. Furthermore, the control device 21 acquires image data from the in-vehicle camera 23, for example.

The storage device 22 includes at least one of, for example, a read only memory (ROM), a random access memory (RAM), a solid state drive (SSD), and a hard disk drive (HDD). Furthermore, the storage device 22 does not need to be physically one element, and may have a plurality of physically separated elements. The storage device 22 stores a program and the like executed by the control device 21. Furthermore, the storage device 22 also stores various pieces of data to be used at the time of execution of a program, such as a learned model for determining whether the behavior of the vehicle 1 has been grasped, a learned model for feeling estimation, and a learned model for vehicle control. These learned models correspond to a trained machine learning model to be described later.

As illustrated in FIG. 1, the in-vehicle camera 23 is an imaging device disposed at a position where the in-vehicle camera 23 can image faces of the plurality of occupants 10A, 10B, and 10C in the vehicle. Image data obtained by the in-vehicle camera 23 is transmitted to the control device 21, and temporarily stored in the storage device 22. Furthermore, the in-vehicle camera 23 functions as a monitoring device for monitoring whether each of the plurality of occupants 10A, 10B, and 10C of the vehicle 1 has grasped the behavior of the vehicle 1.

The control device 21 can detect the direction of the face, the line of sight, the expression, and the like of the occupant 10 based on the image data obtained by the in-vehicle camera 23. Furthermore, the control device 21 can determine the occupant 10 who has not grasped the behavior of the vehicle 1 and feelings of the occupant 10 seen from the expression of the occupant 10 by artificial intelligence (AI) using a learned model subjected to machine learning based on image data having the expression of a person imaged by the in-vehicle camera 23. Note that determining whether there is the occupant 10 who has not grasped the behavior of the vehicle 1 includes determining whether there is the occupant 10 who has not grasped the behavior of the vehicle 1 among the plurality of occupants 10 based on image data obtained by the in-vehicle camera 23. Moreover, the control device 21 can determine the content of the vehicle control from the feelings of the occupant 10 by AI using the learned model subjected to machine learning.

The learned model for determining whether the behavior of the vehicle 1 has been grasped is a trained machine learning model, and has been subjected to machine learning so as to output a feeling estimation result from input data by supervised learning in accordance with a neural network model, for example. The learned model for determination is generated by repeatedly executing learning processing using a learning data set, which is a combination of input data and result data. The learning data set includes, for example, a plurality of pieces of learning data obtained by applying a label of whether the behavior of the vehicle 1 has been grasped, which is output, to input data of image data having a face of a person including the line of sight and the like of the occupant 10 given as input. For example, a person skilled in the art applies the label of whether the behavior of the vehicle 1 has been grasped to the input data. As described above, when receiving input data, the learned model for determination learned by using the learning data set outputs whether the behavior of the vehicle 1 has been grasped by executing arithmetic processing of the learned model.

The learned model for feeling estimation is a trained machine learning model, and has been subjected to machine learning so as to output a feeling estimation result from input data by supervised learning in accordance with the neural network model, for example. The learning data set in the learned model for feeling estimation includes, for example, a plurality of pieces of learning data obtained by applying a label of a feeling of the occupant 10, which is output, to input data of image data having expression of a person including expression and the like of the occupant 10 given as input. For example, a person skilled in the art applies the label of feeling of the occupant 10 to the input data. As described above, when receiving input data, the learned model for feeling estimation learned by using the learning data set outputs a result of estimating the feeling of the occupant 10 by executing arithmetic processing of the learned model.

Note that data used for determining whether the occupant 10 has grasped the behavior of the vehicle may be the same as or different from data used for estimating the feeling of the occupant 10 who has not grasped the behavior of the vehicle 1.

The learned model for vehicle control is a trained machine learning model, and has been subjected to machine learning so as to output a result of the content of the vehicle control from input data by supervised learning in accordance with the neural network model, for example. The learning data set in the learned model for vehicle control includes, for example, a plurality of pieces of learning data obtained by applying a label of the content of the vehicle control, which is output, to input data such as a result of estimating feeling of the occupant 10 given as input. For example, a person skilled in the art applies the label of the content of the vehicle control to the input data. As described above, when receiving input data, the learned model for vehicle control learned by using the learning data set outputs the content of the vehicle control by executing arithmetic processing of the learned model. Examples of the content of the vehicle control include limiting a range of acceleration and setting a steering angle and a lateral G to a threshold or less.

Note that, when determining the content of the vehicle control, the control device 21 may determine the content of the vehicle control from the feeling of the occupant 10 based not on the learned model for vehicle control but on a rule obtained by associating a feeling of the occupant 10 with the content of the vehicle control.

In the on-vehicle system 2 according to the embodiment, the control device 21 executes the vehicle control based on the feeling of the occupant 10. Here, when the plurality of occupants 10A, 10B, and 10C is in the vehicle 1, it may be unclear who is to be a target of feeling estimation by AI of the control device 21. Therefore, the control device 21 prioritizes the occupant 10 who has not grasped the behavior of the vehicle 1, such as decelerating, accelerating, and turning, among the plurality of occupants 10A, 10B, and 10C as a target of feeling estimation.

The control device 21 determines whether the occupant 10 has grasped the behavior of the vehicle 1 from, for example, the line of sight of the occupant 10. That is, as illustrated in FIG. 1, the line of sight LS1 of the occupant 10B who is looking forward at the scenery outside the vehicle from the front seat 32 is in the same direction as a traveling direction A of the vehicle 1, so that the occupant 10B is determined to have grasped the behavior of the vehicle 1, such as accelerating, decelerating, right turning, left turning, and step following. In contrast, the line of sight LS2 of the occupant 10C who is looking away at the scenery outside the vehicle from the rear seat 33 is in a direction different from the traveling direction A of the vehicle 1, so that the occupant 10C is determined not to have grasped the behavior of the vehicle 1, such as accelerating, decelerating, right turning, left turning, and step following.

Note that the occupant 10A who is a driver of the vehicle 1 is driving looking at the traveling direction A of the vehicle 1. The occupant 10A himself/herself operates the vehicle 1 to, for example, accelerate or decelerate. The occupant 10A has thus grasped the behavior of the vehicle 1. Therefore, the control device 21 excludes the occupant from the determination of whether the occupant 10A has grasped the behavior of the vehicle 1. Note that, when the vehicle 1 is traveling by automated driving, whether the occupant 10A has grasped the behavior of the vehicle 1 may also be determined.

When the occupant 10 has not grasped the behavior of the vehicle 1, the occupant 10 cannot predict the behavior of the vehicle 1, such as accelerating, decelerating, right turning, left turning, and step following, so that the occupant 10 may have an unpleasant feeling. Therefore, the control device 21 executes vehicle control of restricting acceleration, deceleration, and the like of the vehicle 1 to reduce the unpleasantness. As described above, the control device 21 executing the vehicle control includes executing vehicle control of limiting a range of acceleration and the like of the vehicle 1 in accordance with a result of estimating feeling of a target occupant at the time when determining that there is the occupant 10 who has not grasped the behavior of the vehicle 1.

Furthermore, when determining that there is no occupant 10 who has not grasped the behavior of the vehicle 1, the control device 21 sets any occupant 10 as a target of feeling estimation. For example, the control device 21 sets, as the target of feeling estimation, the occupant 10C seated on the rear seat 33 where the scenery in front of the vehicle 1 is not easily seen and carsickness more easily occurs than on the front seats 31 and 32. Furthermore, when determining that there is no occupant 10 who has not grasped the behavior of the vehicle 1, the control device 21 may preferentially set the driver as the target of feeling estimation, for example. That is, when determining that there is no occupant 10 who has not grasped the behavior of the vehicle 1, the control device 21 may preferentially determine the occupant 10 to be the target of feeling estimation in accordance with a criterion other than the grasping of the behavior of the vehicle 1.

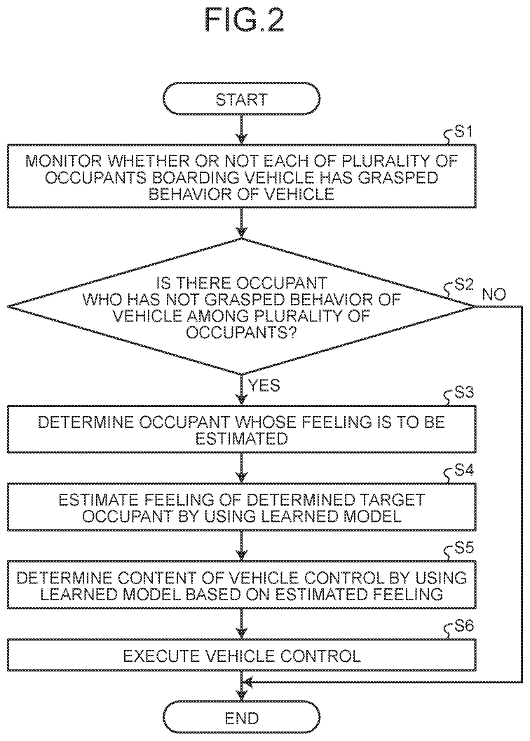

FIG. 2 is a flowchart illustrating one example of control performed by the control device 21.

First, in Step S1, the control device 21 monitors whether each of a plurality of occupants 10 on board the vehicle 1 grasp the behavior of the vehicle 1. Next, in Step S2, the control device 21 determines whether there is an occupant 10 who has not grasped the behavior of the vehicle 1 among the plurality of occupants 10. When determining that there is no occupant 10 who has not grasped the behavior of the vehicle 1, the control device 21 determines No in Step S2, and ends a series of controls. In contrast, when determining that there is the occupant 10 who has not grasped the behavior of the vehicle 1, the control device 21 determines Yes in Step S2, and proceeds to Step S3. In Step S3, the control device 21 determines (specifies) a target occupant whose feeling is to be estimated. Note that determining the target occupant based on a determination result that there is the occupant 10 who has grasped the behavior of the vehicle 1 includes determining, when there is one or more occupants 10 who have not grasped the behavior of the vehicle 1 among a plurality of occupants 10, a target occupant from the one or more occupants 10. Next, in Step S4, the control device 21 estimates the feeling of the determined target occupant by using a learned model for feeling estimation. Next, in Step S5, the control device 21 determines the content of the vehicle control by using the learned model for vehicle control based on the estimated feeling of the target occupant. Next, in Step S6, the control device 21 executes the vehicle control based on the determined content of the vehicle control. Thereafter, the control device 21 ends the series of controls.

The on-vehicle system 2 according to the first embodiment can inhibit the occupant 10 from being unpleasant by prioritizing the feeling of the occupant 10 who has not grasped the behavior of the vehicle 1 and executing the vehicle control.

### Second Embodiment

A second embodiment of the on-vehicle system according to the present disclosure will be described below. Note that, in the second embodiment, description of contents common to those of the first embodiment will be appropriately omitted.

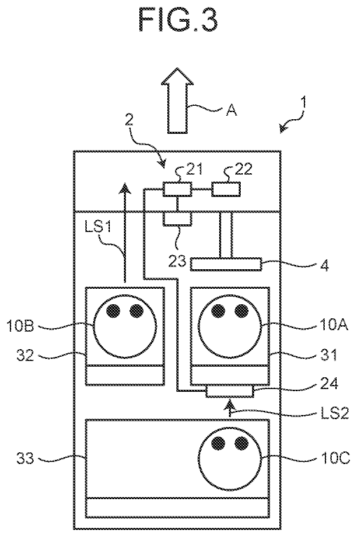

FIG. 3 schematically illustrates the vehicle 1 in which the on-vehicle system 2 according to the second embodiment is mounted.

As illustrated in FIG. 3, a display 24 is attached to the vehicle 1 according to the second embodiment on the back surface of the front seat 31. The display 24 is a display device of an AV device such as a DVD player. Furthermore, in FIG. 3, the occupant 10C seated on the rear seat 33 behind the front seat 31 is viewing a video displayed on the display 24. Then, the control device 21 determines that the occupant 10C viewing the display 24 with the line of sight LS2 being directed to the display 24 has not grasped the behavior of the vehicle 1 by using the learned model for determination of whether the behavior of the vehicle 1 has been grasped based on the image data obtained by the in-vehicle camera 23. Note that the learning data set in the learned model for determination includes, for example, a plurality of pieces of learning data obtained by applying a label of whether the behavior of the vehicle 1 has been grasped, which is output, to input data on whether the occupant 10 is viewing the display 24 given as input.

The occupant 10C who is viewing a video displayed on the display 24 and has not grasped the behavior of the vehicle 1 cannot predict the behavior of the vehicle 1, such as accelerating, decelerating, right turning, left turning, and step following, so that the occupant 10C gets unpleasant. Therefore, the control device 21 preferentially estimates the feeling of the occupant 10C who has not grasped the behavior of the vehicle 1 from the expression of the occupant 10C by using the learned model for feeling estimation based on the image data obtained by the in-vehicle camera 23. Then, the control device 21 executes vehicle control of restricting acceleration and the like by using the learned model for vehicle control based on the feeling estimation result.

Furthermore, in the on-vehicle system 2 according to the second embodiment, the display 24 may be used as a monitoring device that monitors whether each of the plurality of occupants 10 in the vehicle has grasped the behavior of the vehicle 1. That is, the control device 21 may determine whether the occupant 10C has grasped the behavior of the vehicle 1 by detecting the state of a power source of the display 24, for example. Then, when the display 24 is powered on, the control device 21 determines that the occupant 10C is viewing the display 24 and that the occupant 10C has not grasped the behavior of the vehicle 1.

### Third Embodiment

A third embodiment of the on-vehicle system according to the present disclosure will be described below. Note that, in the third embodiment, description of contents common to those of the first embodiment will be appropriately omitted.

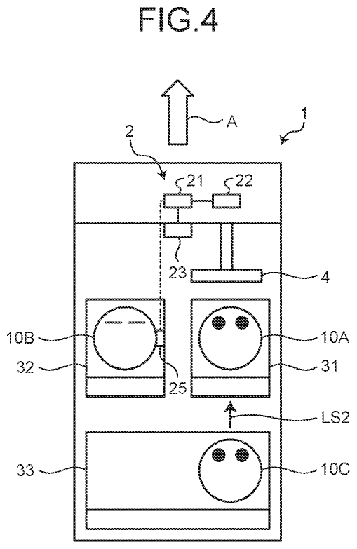

FIG. 4 schematically illustrates the vehicle 1 in which the on-vehicle system 2 according to the third embodiment is mounted.

In FIG. 4, the occupant 10B seated on the front seat 32 is sleeping. Then, the control device 21 determines that the sleeping occupant 10B has not grasped the behavior of the vehicle 1 by using the learned model for determination of whether the behavior of the vehicle 1 has been grasped based on the image data on the occupants 10 imaged by the in-vehicle camera 23. Note that the learning data set in the learned model for determination includes, for example, a plurality of pieces of learning data obtained by applying a label of whether the behavior of the vehicle 1 has been grasped, which is output, to input data of expression and the like of the occupant 10 given as input.

Furthermore, since the control device 21 cannot estimate feeling from the expression of the sleeping occupant 10B, the control device 21 prioritizes estimations of feelings of the other occupants 10A and 10C. When the sleeping occupant 10B awakes, the control device 21 prioritizes estimation of the feeling of the occupant 10B from the expression of the occupant 10B by using the learned model for feeling estimation based on the image data obtained by the in-vehicle camera 23. Then, the control device 21 executes vehicle control of restricting acceleration and the like by using the learned model for vehicle control based on the feeling estimation result.

Furthermore, in the on-vehicle system 2 according to the third embodiment, a wearable terminal may be used as a monitoring device that monitors whether each of the plurality of occupants 10 in the vehicle has grasped the behavior of the vehicle 1. For example, as illustrated in FIG. 4, the occupant 10B seated on the front seat 32 wears a wearable terminal 25. The wearable terminal 25 detects activity information such as movement and a movement direction of the wearable terminal 25 by using, for example, a three-axis acceleration sensor provided in the terminal. The control device 21 acquires the activity information from the wearable terminal 25 by wireless communication or the like. When the occupant 10B is not performing vigorous activity for a certain period of time, the control device 21 determines that the occupant 10B is sleeping. Then, the control device 21 determines that the sleeping occupant 10B has not grasped the behavior of the vehicle 1. Note that the wearable terminal 25 may determine the sleep state of the occupant 10B based on the activity information, and transmit the determination result to the control device 21 by wireless communication or the like.

### Fourth Embodiment

A fourth embodiment of the on-vehicle system according to the present disclosure will be described below. Note that, in the fourth embodiment, description of contents common to those of the first embodiment will be appropriately omitted.

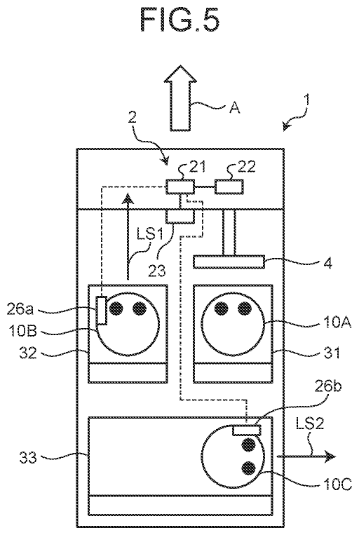

FIG. 5 schematically illustrates the vehicle 1 in which the on-vehicle system 2 according to the fourth embodiment is mounted.

In the vehicle 1 according to fourth embodiment, as illustrated in FIG. 5, the occupants 10B and 10C other than the occupant 10A, who is a driver seated on the front seat 31, wear visual cameras 26a and 26b, respectively. The visual cameras 26a and 26b are sensors that are worn on, for example, heads of the occupants 10B and 10C and sense viewpoints of the occupants 10B and 10C. Examples of the visual cameras 26a and 26b include a head-mounted camera. In the on-vehicle system 2 according to the fourth embodiment, the visual cameras 26a and 26b are used as monitoring devices that monitor whether the occupants 10B and 10C in the vehicle have grasped the behavior of the vehicle 1.

The control device 21 can acquire image data obtained by the visual cameras 26a and 26b by wireless communication with the visual cameras 26a and 26b. Then, the control device 21 can sense the viewpoints of the occupants 10B and 10C based on the image data obtained by the visual cameras 26a and 26b, and detect the directions of the lines of sight LS1 and LS2 of the occupants 10B and 10C based on the sensing results. The control device 21 determines whether the occupants 10B and 10C have grasped the behavior of the vehicle 1 from the directions of the lines of sight LS1 and LS2 of the occupants 10B and 10C by using the learned model for determination of whether the behavior of the vehicle 1 has been grasped. That is, as illustrated in FIG. 5, the line of sight LS1 of the occupant 10B who is looking forward at the scenery outside the vehicle from the front seat 32 is in the same direction as a traveling direction A of the vehicle 1, so that the occupant 10B is determined to have grasped the behavior of the vehicle 1. In contrast, the line of sight LS2 of the occupant 10C who is looking away at the scenery outside the vehicle from the rear seat 33 is in a direction different from the traveling direction A of the vehicle 1, so that the occupant 10C is determined not to have grasped the behavior of the vehicle 1. Note that the learning data set in the learned model for determination includes, for example, a plurality of pieces of learning data obtained by applying a label of whether the behavior of the vehicle 1 has been grasped, which is output, to input data of the line of sight and the like of the occupant 10 given as input.

Thereafter, the control device 21 preferentially estimates the feeling of the occupant 10C who has not grasped the behavior of the vehicle 1 from the expression of the occupant 10C by using the learned model for feeling estimation based on the image data obtained by the visual camera 26b. Then, the control device 21 executes vehicle control of restricting acceleration and the like by using the learned model for vehicle control based on the feeling estimation result.

In the above-described on-vehicle system 2 according to the first to fourth embodiments, for example, when a child is sitting in a child seat installed in the rear seat 33 of the vehicle 1, the child may be preferentially determined as the occupant 10 who has not grasped the behavior of the vehicle 1. For example, the on-vehicle system 2 determines whether a seat belt of the rear seat 33 at the position where the child seat is installed is worn based on a detection result from a seat belt sensor. Then, when determining that the occupant 10 at the position of the rear seat 33 where the seat belt is set does not wear the seat belt, the control device 21 determines that the occupant 10 is a child sitting in the child seat. Then, when the occupant 10 determined not to have grasped the behavior of the vehicle 1 is a child sitting in the child seat, the control device 21 performs vehicle control with stricter restrictions (e.g., range of acceleration G and lateral G of threshold or less). Moreover, when determining that the child is sleeping, the control device 21 may perform the vehicle control with stricter restrictions based on the image data obtained by the in-vehicle camera 23.

The on-vehicle system according to the present disclosure has an effect of inhibiting an occupant who has not grasped the behavior of a vehicle from being unpleasant.

According to an embodiment, the on-vehicle system according to the present disclosure can inhibit an occupant who has not grasped the behavior of the vehicle from being unpleasant by prioritizing the feeling of the occupant and executing the vehicle control.

According to an embodiment, a target occupant can be determined (specified) from one or more occupants who have not grasped the behavior of the vehicle among a plurality of occupants.

According to an embodiment, feeling can be estimated from the expression of the target occupant imaged by an imaging device.

According to an embodiment, the occupant who has not grasped the behavior of the vehicle can be determined based on image data obtained by the imaging device.

According to an embodiment, the occupant who has not grasped the behavior of the vehicle can be inhibited from being unpleasant by sudden acceleration and deceleration.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An on-vehicle system comprising:
a control device;
a monitoring device that monitors whether each of a plurality of occupants in a vehicle has grasped a behavior of the vehicle; and
a storage device that stores a learned model for feeling estimation,
wherein the control device:
determines whether there is an occupant who has not grasped the behavior of the vehicle among the plurality of occupants based on a monitoring result of the monitoring device;
specifies a target occupant whose feeling is to be estimated from the plurality of occupants based on the determination result;
estimates feeling of the target occupant who has been specified by using the learned model; and
executes vehicle control in accordance with a result of estimating the feeling of the target occupant.

2. The on-vehicle system according to claim 1,
wherein specifying the target occupant based on the determination result includes specifying, when there is one or more occupants who have not grasped the behavior of the vehicle in the plurality of occupants, the target occupant from the one or more occupants.

3. The on-vehicle system according to claim 1, further comprising
an imaging device disposed at a position where faces of the plurality of occupants are allowed to be imaged in the vehicle,
wherein the learned model is generated by machine learning so as to derive a result of estimating feeling of a person from image data having expression of the person, and
estimating feeling of the target occupant by using the learned model includes:
giving image data having expression of the target occupant obtained by the imaging device to the learned model; and
obtaining a result of estimating the feeling of the target occupant from the learned model by executing arithmetic processing of the learned model.

4. The on-vehicle system according to claim 3,
wherein the monitoring device includes the imaging device, and
determining whether there is the occupant who has not grasped the behavior of the vehicle includes determining whether there is the occupant who has not grasped the behavior of the vehicle among the plurality of occupants based on image data obtained by the imaging device.

5. The on-vehicle system according to claim 1,
wherein executing the vehicle control includes executing vehicle control of limiting a range of acceleration of the vehicle in accordance with the result of estimating the feeling of the target occupant when it is determined that there is the occupant who has not grasped the behavior of the vehicle.
